(19) United States
(12) Patent Application Publication
(10) Pub. No.: US 2022/0258552 A1
(43) Pub. Date: Aug. 18, 2022

(54) INTEGRATED SUSPENSION AND CLEARANCE ASSEMBLY

(71) Applicant: DEERE & COMPANY, MOLINE, IL (US)

(72) Inventors: FABIO CORZANI, RAVENNA (IT); CARLO MAZZOTTI, CERVIA (IT)

(21) Appl. No.: 17/596,539

(22) PCT Filed: Jun. 10, 2020
(86) PCT No.: PCT/EP2020/066086

§ 371 Date: Dec. 13, 2021

(30) Foreign Application Priority Data
Jun. 14, 2019 (EP) 19180193.5

(51) Int. Cl. B60G 3/12; A01B 76/00

(52) U.S. Cl. CPC B60G 3/12; B60G 2500/30; B60G 2300/082; A01B 76/00

(57) ABSTRACT

A suspension and clearance assembly includes a wheel hub and a hub attachment component. A suspension component is pivotally attached to the hub attachment component at one end, and a first clearance linkage is attached to the hub attachment component with a first pivot and with a second pivot to another end of the suspension component. A second clearance linkage is attachable to an agricultural machine frame and includes a pivot end attached to a third pivot of the first clearance linkage. One end of a cylinder is attached to the first clearance linkage and another end is pivotally attached to the second clearance linkage The cylinder retracts and extends to raise and lower the agricultural machine frame for variable ground clearance. Movements and/or vibrations between the wheel hub and the agricultural machine frame may be damped or suspended hydraulically with the suspension component.

### CROSS-REFERENCE TO RELATED APPLICATIONS

This application is a National Stage of International Application No. PCT/EP2020/066086, filed Jun. 10, 2020. This application claims the benefit of European Patent Application 19180193.5, filed Jun. 14, 2019. The entire disclosures of the applications referenced above are incorporated by reference.

### FIELD

The present disclosure relates to agricultural machines, particularly to self-propelled sprayers and more particularly to an integrated suspension and clearance assembly for self-propelled sprayers.

### BACKGROUND

Agricultural machines, for example a self-propelled sprayer, may be used to distribute chemicals, such as herbicides, pesticides, and fertilizes over crops in a field during a spraying operation. The chemicals may be maintained in a liquid solution and stored in a tank which is generally mounted on the frame of the self-propelled sprayer. The chemicals may discharge through nozzles mounted on spray booms extending sideward from the machine during a spraying operation. Self-propelled sprayers may have wheels configured to pass between crop rows during the spraying operation over the crops in a field. Crop damage is one of the vital aspects of ineffective spraying. To avoid crop damage wheel width and track width should be appropriate.

Along with this, the ground clearance of the self-propelled sprayer plays an important role during spraying operation to avoid crop damage. While a usual height of a self-propelled sprayer may be used to spray over short length crops, different heights of self-propelled sprayers may be needed over the growing phases of crops. For example, high clearance sprayers may be used for matured crops. While high clearance sprayers provide enough clearance to pass over the top of matured crops, they suffer from various limitations. For example, high clearance sprayers may not be effective in spraying operations over short length crops. There may be distortion in spray patterns due to wind while spraying from a high height over short length crops and to avoid the distortion spray booms may be lowered to specific height adding complexity in boom lifting mechanisms. Moreover, high clearance sprayers may have an overall height that exceeds highway height restrictions, thereby making the transport of such vehicles to and from the field difficult and it may exceed the height limit when placed on a transport trailer. Thus, measures may need to be taken to lower the vehicle to an acceptable transport height, such as deflating the tires or entirely removing the wheels.

While dropdown gear boxes may be developed and configured to lower the frame of high clearance sprayers as per the need to spray over short length crops, gear boxes increase cost and complexity of the sprayer. Complexity may lead to breakdown of sprayers and in turn delays in applying chemicals to the crops. Moreover, few solutions may be available to increase or decrease the ground clearance of an existing vehicle but those may be complicated, complex, component intensive and may require the removal of existing vehicle components and/or the addition of new components.

Due to addition of new parts to an agricultural sprayer for suspension and/or clearance purpose, the sprayer may get bulky which may lead to crop interference during its travel from crop rows for spraying operations and in turn may result in crop damage. Further, addition of new components may make the machine complex and costly and may further pose instability during spraying operations. Instability may also be hazardous during transportation of such heavy agricultural sprayers to and from the field.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An integrated suspension and clearance assembly for an agricultural machine is provided, wherein the assembly includes a wheel hub and a wheel hub attachment component, fixedly attachable to the wheel hub. The assembly further includes a suspension component with one end pivotally attached to the wheel hub attachment component and a first clearance linkage with a first pivot attached to the wheel hub attachment component and with a second pivot attached to another end of the suspension component. A second clearance linkage is fixedly attachable to an agricultural machine frame and includes a pivot end attached to a third pivot of the first clearance linkage. A telescopic cylinder is arranged with one end fixedly attached to the first clearance linkage and with another end pivotally attached to the second clearance linkage, wherein the telescopic cylinder is variably retractable and extendable to change pivotal positions of the first and the second clearance linkages relative to each other to raise and lower an agricultural machine frame relative to the wheel hub for variable ground clearance during agricultural operations. At the same time, movements and/or vibrations between the wheel hub and an agricultural machine frame can be damped or suspended hydraulically with the suspension component.

Moreover, the telescopic cylinder may be a hydraulic cylinder. Alternatively, the telescopic cylinder can be an electric actuator or pneumatic cylinder or any such similar component. The telescopic cylinder can be remotely operable to extend and retract according to the need. There might be further the possibility to combine the operation of the telescopic cylinder with a crop sensor, detecting the height of the crop or plants and adjusting the telescopic cylinder accordingly for an automatic, sensor based, height regulation/adjustment of the machine. A respective controller receiving the sensor data for sensing/detecting the height of the crop or plants will then be connected to a respective hydraulic, electric or pneumatic control for the cylinder.

The wheel hub attachment component, the first clearance linkage and the second clearance linkage include plates, panels, sheets or any similar flat surfaces in order to make the assembly compact in width to fit in crop rows without any crop interference during spraying operations. As the suspension component is integrated in between the wheel hub attachment component and the first clearance linkage the compactness of the suspension and clearance assembly is optimized.

The first clearance linkage and the second clearance linkage include arc shaped or curved, or angular plates in order to accommodate movement around the wheel hub during actuation of the telescopic cylinder for providing ground clearance to the agricultural machine. The arc shaped plates having a first and a second end portion for providing respective joints with other mentioned components. Alternatively, the wheel hub attachment component, the first clearance linkage and the second clearance linkage can be manufactured and mounted in such a way that it can be placed with a tolerance within the inner diameter of wheel for even more compactness.

The wheel hub attachment component include a wheel hub portion coaxially arranged to the wheel hub and a connecting portion offset from the wheel hub portion. The wheel hub portion can be of a ring-shaped form or of other shaped form surrounding the circumference of a wheel hub entirely. The connecting portion extends from the wheel hub portion and includes the first pivot of the first clearance linkage.

In various implementations, a first end portion of the first clearance linkage is pivotally attached to the connecting portion of the wheel hub attachment component and the suspension component is arranged between the wheel hub and the first pivot of the first clearance linkage. Alternatively, the suspension component can be arranged anywhere on the assembly to damp vibrations between wheel hub and agricultural machine frame, as long as a relative movement between the wheel hub component and the first clearance linkage can be associated with an extraction or retraction (length change) of the suspension component.

The telescopic cylinder is arranged to extend from the first end portion of the first clearance linkage to a pivot located between the first and second end portion of the second clearance linkage.

The first end portion of the second clearance linkage is fixedly attachable to an agricultural machine frame. It is not necessarily needed that the attachment of the second clearance linkage is directly connected to the frame, wherein the movement of the first end portion of the second clearance linkage relative to the wheel hub is directly associated to a height clearance change of the frame relative to the ground. The second end portion of the first clearance linkage and the second end portion of the second clearance linkage are linked together by the third pivot, so that the first and second clearance linkages are providing a scissor type supporting structure.

Agricultural machine includes a machine frame with ground engaging wheels. Each wheel is mounted on a wheel hub associated to an integrated suspension and clearance assembly. Further, an agricultural machine is one of a self-propelled sprayer, trailed sprayer, windrower or tractor. It would be also possible to equip other type of agricultural machines with such an integrated suspension and clearance assembly, e.g. a harvesting machine.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a front perspective view of an agricultural machine incorporating principles of the present disclosure.

FIG. 2 is a front perspective view of a frame and wheel portion of the agricultural machine of FIG. 1.

FIG. 3 is a side view of an integrated suspension and clearance assembly in a retracted position.

FIG. 4 is a front perspective view of FIG. 3.

FIG. 5 is a side view of the integrated suspension and clearance assembly of FIG. 3 in an extended position.

FIG. 6 is a front perspective view of FIG. 5.

FIG. 7 is a front view of the frame and wheel portion of FIG. 2 traveling through a crop row.

In the drawings, reference numbers may be reused to identify similar and/or identical elements.

### DETAILED DESCRIPTION

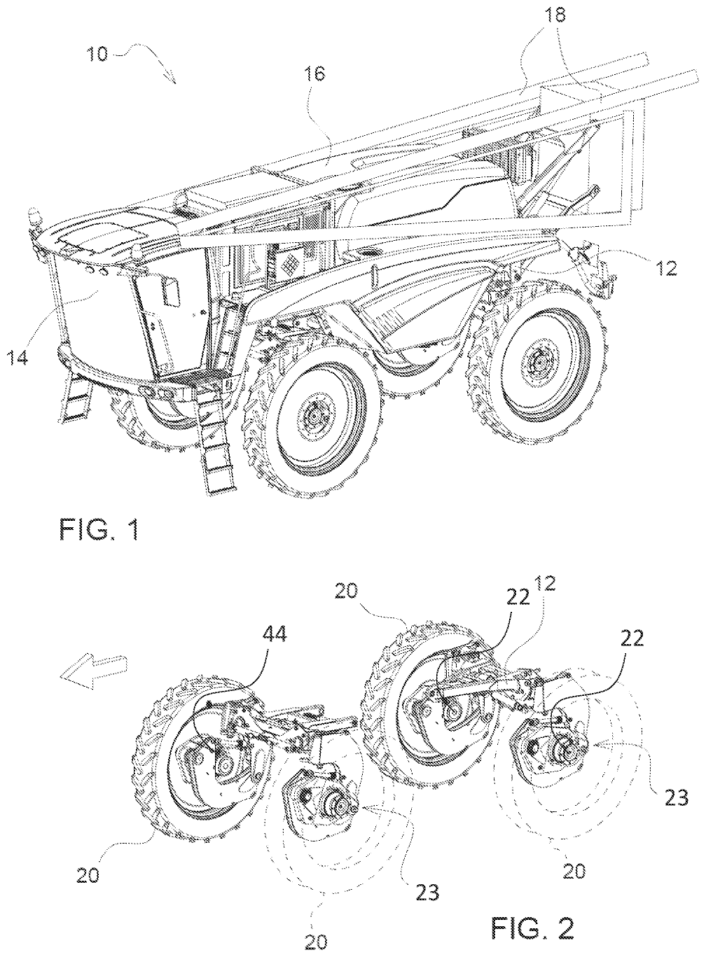

Referring now to FIG. 1, there is shown an agricultural machine such as a self-propelled sprayer 10. The self-propelled sprayer 10 includes a frame 12 that provides a structure for mounting numerous components associated with the self-propelled sprayer 10 thereon. For example, the self-propelled sprayer 10 includes a cab 14 which is mounted on the frame 12. The cab 14 houses a seat for an operator and several controls which may be manipulated by the operator in order to control operation of the self-propelled sprayer 10 during performance of a work function such as an agricultural spraying function.

The self-propelled sprayer 10 further includes a storage tank 16 which stores a spray liquid including chemicals such as herbicides, pesticides, and fertilizers that are to be sprayed on a field. The storage tank 16 is mounted on the frame 12 at a location which is aft of the cab 14. The self-propelled sprayer 10 also includes a spray boom assembly 18 operable to distribute the chemicals in the storage tank 16 over a wide area in a field. In particular, the liquid chemicals are distributed by a number of nozzles (not shown), which are spaced along the spray boom assembly 18, through which the liquid chemicals are sprayed as the self-propelled sprayer 10 is propelled along the rows associated with a field of crop or plants. In alternative embodiments, spray boom assembly 18 may be located at different locations on the self-propelled sprayer 10 such as at the front end or in the mid-portion of the self-propelled sprayer 10.

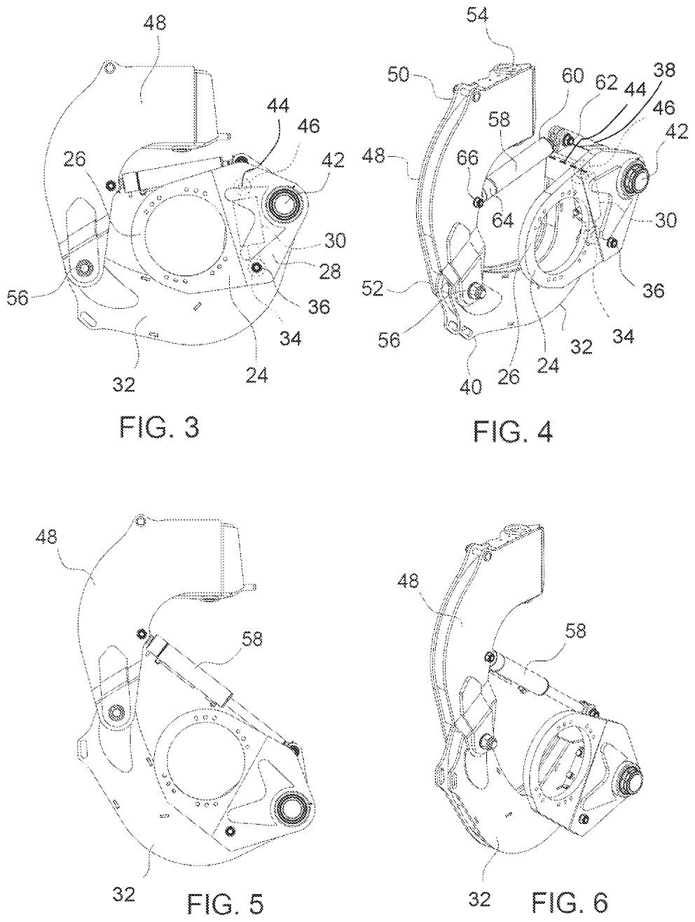

As best shown in FIG. 2, the frame 12 is supported by front and rear ground engaging wheels 20. The ground engaging wheels 20 are each mounted on a wheel hub 22. On the inner side of each wheel 20 and wheel hub 22, respectively, the self-propelled sprayer 10 is equipped with integrated suspension and clearance assemblies 23, best shown in FIG. 2. The integrated suspension and clearance assemblies 23, as shown in more detail in FIG. 3 to FIG. 6, each includes a wheel hub attachment component 24, fixedly attached to a respective wheel hub 22. The wheel hub attachment component 24 includes a wheel hub portion 26 and a connecting portion 28. The wheel hub portion 26 is coaxially arranged on the wheel hub 22 and the connecting portion 28 is offset from the wheel hub portion 26. Further, each integrated suspension and clearance assembly 23 includes a suspension component 30 and a first clearance linkage 32. One of the ends 34 of the suspension component 30 is pivotally attached at a pivot 36 to the wheel hub attachment component 24. The suspension component 30 includes accumulator and telescopic cylinder assembly or pneumatic spring or similar motion regulating assembly.

As shown further in FIG. 3 to FIG. 6, the first clearance linkage 32 has two end portions, a first end portion 38 and a second end portion 40. The first end portion 38 of the first clearance linkage 32 is attached pivotally to a first pivot 42 to the connecting portion 28 of the wheel hub attachment component 24 and further attached pivotally with a second pivot 44, also shown in FIG. 2 and FIG. 4 as dotted line, to another end 46 of the suspension component 30.

Hence, the suspension component 30 is arranged between the wheel hub 22 and the first pivot 42 of the first clearance linkage 32 and is extending from its one end 34 with pivot 36 on the connecting portion 28 of the wheel hub attachment component 24 to its other end 46 with pivot 44 on the first end portion 38 of the first clearance linkage 32. Vibration and shocks generated due to field undulations or irregularities in the field will be transferred to the wheel hub 22. In motion of the self-propelled sprayer 10, this will cause to move the wheel hub attachment component 24 and the first clearance linkage 32 to move relative to each other. Such movements are effectively absorbed by the suspension component 30 of the self-propelled sprayer 10.

Like the first clearance linkage 32, a second clearance linkage 48 has two end portions, namely a first end portion 50 and a second end portion 52 or pivot end. The first end portion 50 of the second clearance linkage 48 is fixedly attached to the frame 12 at point 54 and the second end portion 52 of the second clearance linkage 48 is pivotally attached to a third pivot 56 on the second portion 40 of the first clearance linkage 32. As shown in FIG. 3 and FIG. 4, the wheel hub attachment component 24, the first clearance linkage 32 and the second clearance linkage 48 are all made of flat-shaped plates or any similar flat surfaces, wherein the first clearance linkage 32 and the second clearance linkage 48 includes an arc-curved, bend, bow, half-moon, semi-circular or any similar shaped form.

Continuing with FIG. 4, a telescopic cylinder 58 has two ends. One of the ends 60 of the telescopic cylinder 58 is fixedly attached at point 62 to the first end portion 38 of the first clearance linkage 32. Another end 64 of the telescopic cylinder 58 is pivotally attached at pivot 66 between the first end portion 50 and second end portion 52 of the second clearance linkage 48. The telescopic cylinder 58 is arranged to extend and retract between the first clearance linkage 32 and the second clearance linkage 48, so as to move the first and second clearance linkage (32, 48) in a scissor-type relative movement to each other when in motion. In some implementations, the telescopic cylinder 58 is a hydraulic cylinder.

As shown in FIG. 3 to FIG. 6, the telescopic cylinder 58 may be extended and retracted hydraulically in a variable manner to variably increase and decrease ground clearance of the self-propelled sprayer 10. Extension and retraction of the telescopic cylinder 58 leads to change in pivotal positions of the first clearance linkage 32 and the second clearance linkage 48 relative to each other which raises and lowers the frame 12 of the self-propelled sprayer 10 relative to the wheel hub from its initial position to maximum height. Simultaneously, the suspension component 30 hydraulically damps the movements and/or vibrations between the wheel hub 22 and the frame 12.

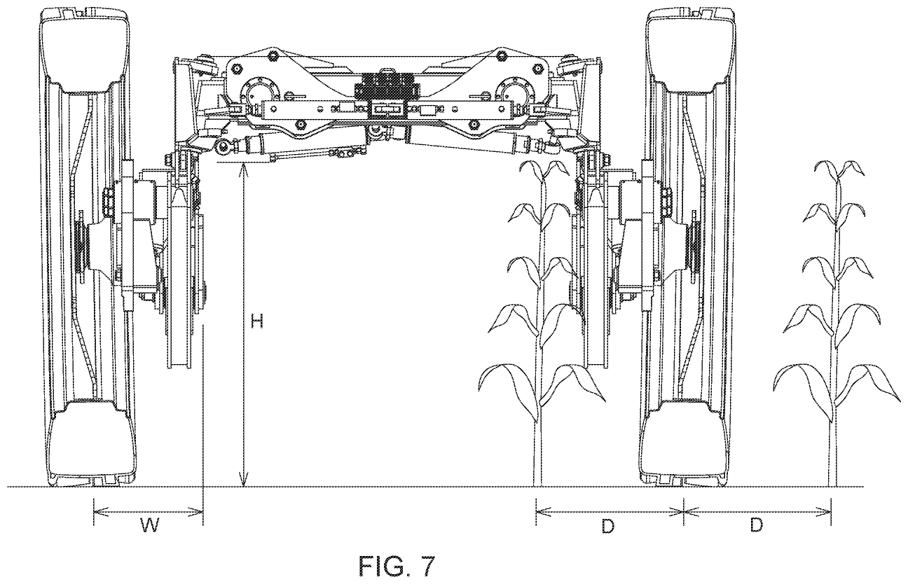

Thus, in the above described implementation, the integrated suspension and clearance assembly 23 is mounted on each ground engaging wheel 20 of the agricultural sprayer 10. The integrated suspension and clearance assembly 23 is combined or arranged integrally which allows for a compact design with a width “W” as shown in FIG. 7. Further, the compact design of such an assembly 23 allows easy travel of the self-propelled sprayer 10 from the crop rows, where the ground engaging wheels 20 can travel at distance “D” from either side of the ground engaging wheel 20 to the crop rows. Moreover, the assembly allows increased stability for the self-propelled sprayer 10 in lowered position due to its compact width “W”. The maximum ground clearance of the self-propelled sprayer 10 is defined by height “H” above the ground.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

1. An integrated suspension and clearance assembly for an agricultural machine comprising:
a wheel hub;
a wheel hub attachment component fixedly attached to the wheel hub;
a suspension component with one end pivotally attached to the wheel hub attachment component;
a first clearance linkage with a first pivot attached to the wheel hub attachment component and with a second pivot attached to another end of the suspension component;
a second clearance linkage fixedly attachable to a frame of the agricultural machine and including a pivot end attached to a third pivot of the first clearance linkage; and
a telescopic cylinder with one end fixedly attached to the first clearance linkage and another end pivotally attached to the second clearance linkage,
wherein the telescopic cylinder variably retracts and extends to change pivotal positions of the first clearance linkage and the second clearance linkage relative to each other to raise and lower the agricultural machine frame relative to the wheel hub for variable ground clearance during agricultural operations, while at the same time, the suspension component dampens or suspends movements or vibrations between the wheel hub and the frame of the agricultural machine.

2. The integrated suspension and clearance assembly of claim 1, wherein the suspension component includes a dampening and/or suspension device.

3. The integrated suspension and clearance assembly of claim 1, wherein the telescopic cylinder is a hydraulic cylinder.

4. The integrated suspension and clearance assembly of claim 1, wherein one or more of the wheel hub attachment component, the first clearance linkage and the second clearance linkage include plates.

5. The integrated suspension and clearance assembly of claim 1, wherein said first clearance linkage and the second clearance linkage each include arc shaped plates, and wherein the arc shaped plates have a first end portion and a second end portion.

6. (canceled)

7. (canceled)

8. The integrated suspension and clearance assembly of claim 5, wherein the telescopic cylinder is arranged to extend from the first end portion of the first clearance linkage to a pivot located between the first end portion and second end portion of the second clearance linkage.

9. The integrated suspension and clearance assembly of claim 5, wherein the first end portion of the second clearance linkage is fixedly attachable to the frame of the agricultural machine.

10. The integrated suspension and clearance assembly of claim 5, wherein the second end portion of the first clearance linkage and the second end portion of the second clearance linkage are linked together by the third pivot.

11. (canceled)

12. (canceled)

13. The integrated suspension and clearance assembly of claim 1, wherein the wheel hub attachment component includes a wheel hub portion coaxially arranged to the wheel hub and a connecting portion offset from the wheel hub portion, and wherein the connecting portion incudes the first pivot of the first clearance linkage.

14. The integrated suspension and clearance assembly of claim 13, wherein the first end portion of the first clearance linkage is pivotally attached to the connecting portion of the wheel hub attachment component, and wherein the suspension component is arranged between the wheel hub and the first pivot of the first clearance linkage.

15. The integrated suspension and clearance assembly of claim 1, wherein the agricultural machine is one of a self-propelled sprayer, a trailed sprayer, a windrower, or a tractor.

16. Agricultural machine comprising:
a machine frame that includes a plurality of ground engaging wheels; and
a plurality of integrated suspension and clearance assemblies,
wherein each integrated suspension and clearance assembly includes:
a wheel hub,
a wheel hub attachment component fixedly attached to the wheel hub,
a suspension component with one end pivotally attached to the wheel hub attachment component,
a first clearance linkage with a first pivot attached to the wheel hub attachment component and with a second pivot attached to another end of the suspension component,
a second clearance linkage fixedly attachable to the machine frame and that includes a pivot end attached to a third pivot of the first clearance linkage, and
a telescopic cylinder with one end fixedly attached to the first clearance linkage and another end pivotally attached to the second clearance linkage,
wherein the telescopic cylinder variably retracts and extends to change pivotal positions of the first clearance linkage and the second clearance linkage relative to each other to raise and lower the machine frame relative to the wheel hub for variable ground clearance during agricultural operations, while at the same time, the suspension component dampens or suspends movements or vibrations between the wheel hub and the machine frame, and
wherein each ground engaging wheel of the plurality of ground engaging wheels is mounted on a wheel hub of a different integrated suspension and clearance assembly of the plurality of integrated suspension and clearance assemblies.

17. The agricultural machine of claim 16, wherein the telescopic cylinder of each integrated suspension and clearance assembly is a hydraulic cylinder.

18. The agricultural machine of claim 16, wherein the first clearance linkage and the second clearance linkage of each integrated suspension and clearance assembly include arc shaped plates having a first end portion and a second end portion.

19. The agricultural machine of claim 18, wherein the telescopic cylinder of each integrated suspension and clearance assembly is arranged to extend from the first end portion of the first clearance linkage to a pivot located between the first end portion and second end portion of the second clearance linkage.

20. The integrated suspension and clearance assembly of claim 18, wherein the first end portion of the second clearance linkage of each integrated suspension and clearance assembly is fixedly attached to the machine frame.

21. The integrated suspension and clearance assembly of claim 18, wherein the second end portion of the first linkage and the second end portion of the second clearance linkage of each integrated suspension and clearance assembly are linked together by the third pivot.

22. The agricultural machine of claim 16, wherein the wheel hub attachment component of each integrated suspension and clearance assembly includes a wheel hub portion coaxially arranged to the wheel hub and a connecting portion offset from the wheel hub portion, and wherein the connecting portion incudes the first pivot of the first clearance linkage.

23. The agricultural machine of claim 22, wherein the first end portion of the first clearance linkage of each integrated suspension and clearance assembly is pivotally attached to the connecting portion of the wheel hub attachment component, and wherein the suspension component of each integrated suspension and clearance assembly is arranged between the wheel hub and the first pivot of the first clearance linkage.

24. The agricultural machine of claim 16, wherein the agricultural machine is one of a self-propelled sprayer, a trailed sprayer, a windrower, or a tractor.
